(19) United States
(12) Patent Application Publication
(10) Pub. No.: US 2010/0242705 A1
(43) Pub. Date: Sep. 30, 2010

(54) STRING CLAMPING PLATE ALIGNMENT TOOL FOR DOUBLE LOCKING TREMOLO

(76) Inventor: Steven Donald Powell, Fremont, CA (US)

Correspondence Address: GREGORY SMITH & ASSOCIATES, 3900 NEWPARK MALL ROAD, 3RD FLOOR, NEWARK, CA, 94560, US

(21) Appl. No.: 12/751,950

(22) Filed: Mar. 31, 2010

Related U.S. Application Data
(60) Provisional application No. 61/211,639, filed on Mar. 31, 2009.

(51) Int. Cl. G10D 3/00

(52) U.S. Cl. 84/313

(57) ABSTRACT

An alignment tool comprises a tongue and a handle attached to a handle stem. The tongue includes a prying tip disposed at an angle to a long axis of the handle stem. The size and shape of the prying tip are well suited for freeing a jammed string clamping plate in a double locking tremolo without causing damage to the tremolo or guitar to which the tremolo is attached. The alignment tool may be used by a person with average mechanical skills to remove or align a string clamping plate or remove a broken or worn string. Some embodiments of the invention include dimensions for preventing accidental dislocation of an alignment seat under a string clamping plate. Other embodiments of the invention comprise steps in a method for removing or aligning a string clamping plate in a double locking tremolo.

### CROSS REFERENCE TO RELATED APPLICATIONS

This application claims the benefit of U.S. Provisional Application No. 61/211,639 filed Mar. 31, 2009, incorporated herein by reference in its entirety.

### FIELD OF THE INVENTION

Embodiments of the invention relate to musical instruments and in particular to a tool for repairing guitars fitted with double locking tremolos.

### BACKGROUND

From time to time it is necessary to replace a string on a musical instrument such as a guitar. A string for use on a guitar with a fixed bridge has a loop or ball at one end for attaching the string to the bridge. Replacing a string by disengaging the loop or ball from a post or slot in a fixed bridge is not difficult. However, many guitars do not have a fixed bridge. Instead, a guitar may have a tremolo, which lacks the string anchoring means found on a fixed bridge.

A tremolo replaces a fixed bridge with a “floating” bridge. A tremolo is pivotally connected to the guitar's body and includes a lever which may be pressed to modify the tension of the strings while playing the guitar. Pressing the lever rocks the floating bridge back and forth and causes modulation of the sound from the instrument. A well-known type of tremolo is known as a Floyd Rose™ style tremolo, referred to herein as a double locking tremolo. Examples of double locking tremolos appear in U.S. Pat. No. 4,171,661 and No. 4,497,236, the specifications of which are incorporated herein by reference.

A string is held in a double locking tremolo by a clamping device referred to as a saddle. A clamping screw in the saddle provides an adjustable amount of clamping force for holding strings of different sizes and construction materials. Tightening the clamping screw presses a string clamping plate against a string, holding the string against a wall of a string clamping plate slot in the saddle with sufficient force to prevent the string from slipping. To remove a string, for example to replace a broken string, the clamping screw is loosened and the string clamping plate removed from the saddle to remove the compression force holding the string. A string clamping plate may also be removed to replace a worn or damaged plate.

A substantial amount of force may be needed to hold a string between a string clamping plate and a saddle. Pressure from the clamping screw may cause damage to the string clamping plate, for example by causing a crack in the plate. Tightening a clamping screw further after a string clamping plate has cracked may cause the sides of the plate to spread apart, jamming the string clamping plate in the spring clamping plate slot in the saddle. Or, the string clamping plate may jam by being tilted or rotated by pressure from the clamping screw. A string clamping plate may also become jammed by corrosion or foreign material in the saddle. Removing a jammed string clamping plate without causing damage to the tremolo or other parts of the guitar can be very difficult.

Various probes, such as knives, screwdrivers, picks, needle-nose pliers, hemostat clamps, and the like have been used to remove jammed string clamping plates from tremolos. Use of such tools often leads to damage to parts of the saddle, especially the walls of the slot in which the string clamping plate is held. String clamping plates may also be damaged during removal attempts with such tools. It is also easy for such tools to slip and cause damage to other parts of a guitar since a considerable amount of force may be needed to free a jammed string clamping plate. Furthermore, it is easy to push out an alignment seat pressed into the slot under a string clamping plate by pressing too hard with a tool from above. Sometimes an alignment seat is deliberately removed to make it easier to push out a damaged string clamping plate.

The alignment seat, which is made from a relatively soft metal such as brass, is intended to align the tip of a clamping screw with a small aperture in a string clamping plate by placing the plate a predetermined distance above the bottom of the saddle. Once an alignment seat has been removed, either deliberately or accidentally, it is difficult to reinstall without damage to the alignment seat or saddle. Changing an alignment seat or string clamping plate may also cause undesirable changes in the character of sound produced by a guitar, so the guitar may need extensive adjustment and retuning to achieve a preferred intonation when string clamping plates or alignment seats are repositioned or replaced. Because of these difficulties, many guitar players find that replacing broken strings or jammed or damaged string clamping plates is best done by a person skilled in the maintenance and repair of double locking tremolos.

Some solutions for removing a string clamping plate from a double locking tremolo are known in the art. For example, U.S. Pat. No. 5,686,681 to Steven Donald Powell, incorporated herein by reference in its entirety, describes a string clamping plate extractor for a double locking tremolo. Even with a string clamping plate extractor as described in U.S. Pat. No. 5,686,681, it may be very difficult to remove or align a string clamping plate that is tightly jammed into the slot in a saddle in the tremolo.

What is needed is a device for removing and aligning jammed or damaged string clamping plates in double locking tremolos without also repositioning or removing alignment plates under the string clamping plates. What is further needed is a device for replacing a string or string clamping plate without requiring the services of a person skilled in the maintenance and repair of double locking tremolos. What is also needed is a device for replacing a string or aligning a string clamping plate without causing undesirable changes in the intonation of a guitar with a double locking tremolo.

### SUMMARY

Some embodiments of the invention comprise a string clamping plate alignment tool for a double locking tremolo. A string clamping plate alignment tool in accord with an embodiment of the invention, referred to herein as an alignment tool, includes a handle attached to an end of a handle stem and a tongue attached to an opposite end of the handle stem. The tongue includes a prying tip disposed at an angle from a central long axis of the handle stem. The prying tip has an approximately rectangular end face with a width dimension selected for a sliding fit within the width of a string clamping plate slot in a saddle in the tremolo. A height dimension of the prying tip end face is selected to be small enough that the alignment tool can be inserted in a small gap between a string and a string clamping plate to separate the string and the plate. The angled disposition of the prying tip permits a substantial force to be generated by leverage between a string clamping plate in contact with the prying tip and a side wall or edge of the string clamping plate in contact with the tongue of the alignment tool. Embodiments of the invention comprising an alignment tool are beneficial for freeing a string clamping plate that has become jammed into the string clamping plate slot, and for aligning a string clamping plate so its sides are parallel with the walls of a spring clamping plate slot in a saddle.

Some embodiments of an alignment tool have a tongue made with a width dimension at a selected distance from an end of the tongue that prevents the tool from being inserted deeply enough into a string clamping plate slot to move an alignment seat pressed into the slot.

Some embodiments of the invention comprise a combination of an alignment tool and a double locking tremolo. Some embodiments of the invention comprising a combination include a string clamping plate extractor as described in U.S. Pat. No. 5,686,681.

Some embodiments of the invention comprise steps in a method for removing a string from a double locking tremolo. A method in accord with an embodiment of the invention may optionally comprise steps for aligning a string clamping plate in a string clamping plate slot in a tremolo.

This section summarizes some features of the present invention. These and other features, aspects, and advantages of the embodiments of the invention will become better understood with regard to the following description and upon reference to the following drawings, wherein:

### BRIEF DESCRIPTION OF THE DRAWINGS

FIG. 1 is pictorial view of an example of a single string clamping plate alignment tool.

FIG. 2 is a side view of the alignment tool of FIG. 1, in which a circle indicates the area of an enlarged partial side view in FIG. 4.

FIG. 3 is a view toward an end of the alignment tool of FIG. 1 and FIG. 2.

FIG. 4 is an enlarged partial side view of the area enclosed within a circle in FIG. 1.

FIG. 5 is a view toward another end of the alignment tool of FIGS. 1-4, in a viewing direction indicated by a phantom line labeled B-B in FIG. 4.

FIG. 6 is a sectional view of the tongue of the alignment tool of FIG. 4, taken along a phantom line labeled C-C in FIG. 4.

FIG. 7 is a top view of an example of a double locking tremolo for a six-string guitar, showing a saddle and its associated clamping screw and string clamping plate, and further showing a string fragment clamped in the leftmost saddle (PRIOR ART).

FIG. 8 is a sectional view of the double locking tremolo of FIG. 7, taken along a phantom line labeled A-A in FIG. 7 (PRIOR ART).

FIG. 9 shows an alignment tool with the sectional view of a saddle from FIG. 8 in a first example of alignment tool position and motions for removing a string and aligning a string clamping plate.

FIG. 10 shows the alignment tool and sectional view of a saddle from FIG. 9 in a second example of alignment tool position and motions for removing a string and aligning a string clamping plate.

FIG. 11 shows the alignment tool and sectional view of a saddle from FIG. 9 in a third example of alignment tool position and motions for removing a string and aligning a string clamping plate.

FIG. 12 shows an alternative position for repairing a double locking tremolo with an alignment tool in accord with an embodiment of the invention, and further illustrates an alternative embodiment of an alignment tool having a tongue thickness dimension selected to prevent the alignment tool from pressing against an alignment seat in the tremolo.

### DESCRIPTION

Embodiments of the invention comprise a tool and a method for aligning and removing string clamping plates from double locking tremolos. A tool in accord with an embodiment of the invention, referred to herein as an alignment tool, is well suited for repairing a tremolo in which a string clamping plate is jammed into a string clamping plate slot in a saddle. An alignment tool may also be used to accurately position a string clamping plate so that an aperture in the plate will be in position for engagement with the tip of a clamping screw in a saddle. An alignment tool may also be used to remove a damaged string clamping plate, for example an excessively worn or cracked plate, and to remove broken strings from a tremolo. Embodiments of the invention are intended for use by a person having average skill in the care and maintenance of electric guitars, rather than by a person having substantial skill and experience in the repair and maintenance of double locking tremolos. Embodiments of the invention are especially useful for performing repairs quickly and efficiently, for example to replace a guitar string during a musical performance without changing the intonation of the guitar.

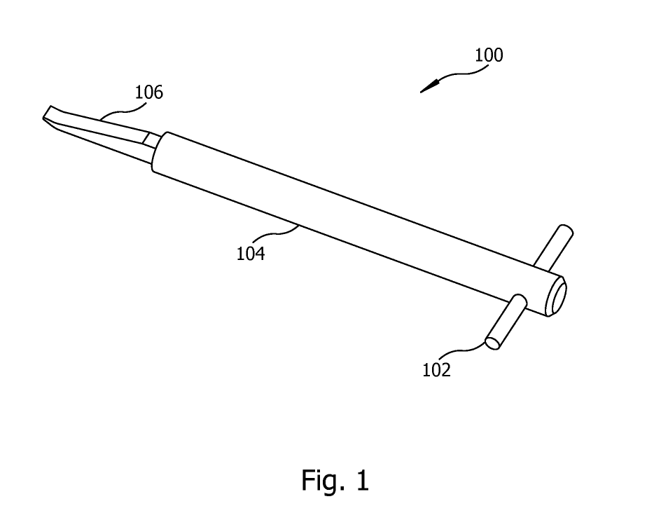

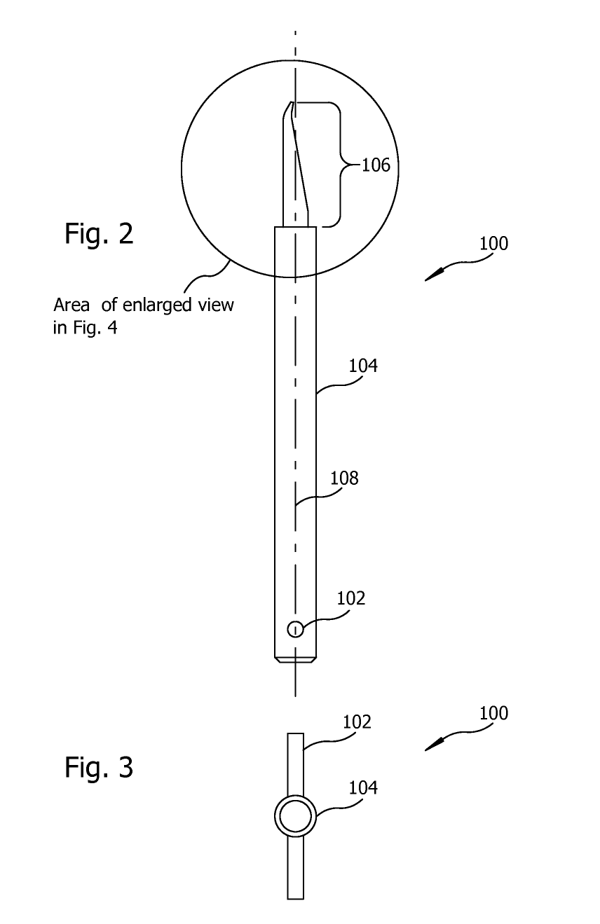

An example of an alignment tool is shown in the pictorial view of FIG. 1. An alignment tool 100 includes a tongue 106 attached to a first end of a handle stem 104. A handle 102 at a second end of the handle stem 104 is provided for comfortably and securely grasping the alignment tool 100 while it is in use. The alignment tool of FIG. 1 is shown in a side view in FIG. 2 and in an end view in FIG. 3. A central long axis 108 of the alignment tool 100 is shown in FIG. 2. In the example illustrated in FIG. 2 and FIG. 3, the handle stem 104 has a cylindrical shape. In other embodiments, the handle stem may be provided with a polygonal cross section.

Embodiments of an alignment tool may be made from a durable metal such as tool steel or stainless steel. An alignment tool may optionally include surface treatments for passivation and may further include treatments to increase material hardness.

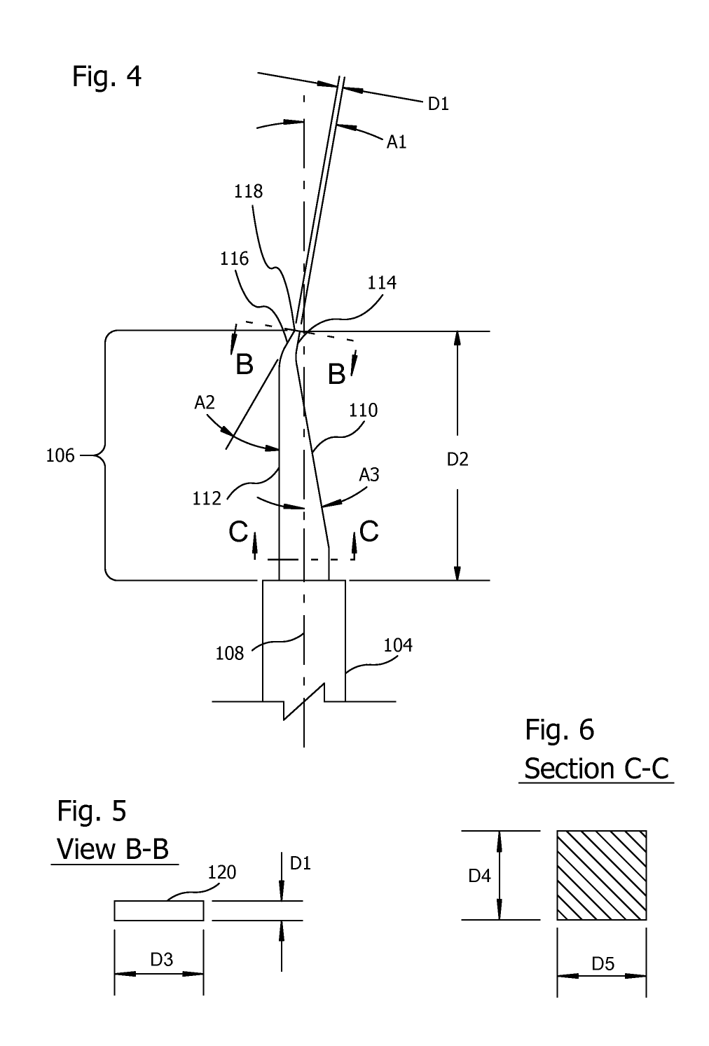

FIG. 2 includes a circle marking the approximate area of an enlarged view of the tongue 106 and a portion of the handle stem 104 shown in FIG. 4. As shown in FIG. 4, the tongue 106 is attached at a first end to the first end of the handle stem 104. The tongue may optionally be made as an integral part of the handle stem 104. A second end of the tongue 106 is formed into a prying tip 118. The prying tip 118 comprises an inside face 114, an outside face 116, and an end face 120 sharing edges in common with the inside and outside faces.

The shape of the end face 120 is shown in View B-B in FIG. 5. A viewing direction for View B-B is indicated with a phantom line marked B-B in FIG. 4. FIG. 5 also shows a height dimension D1 and a width dimension D3 for the end face 120. In one embodiment, D1 is 0.016 inch (0.006 cm) and D3 is 0.15 inch (0.06 cm). Dimension D1 is preferably in a range from 0.01 inch (0.004 cm) to 0.02 inch (0.06 cm). Dimension D3 is preferably selected to provide a sliding fit between the tongue 104 and the sides of a string clamping plate slot in a double locking tremolo. The entire length of the tongue may optionally be made with width dimension D3, or parts of the tongue near the handle stem 104 may optionally be made wider to limit a depth to which an alignment tool may be inserted into a string clamping plate slot in a saddle.

Continuing with FIG. 4, the outside surface 116 of the prying tip 118 is formed at an acute angle A2 to an outside face 112 of the tongue 106. The inside surface 114 of the prying tip 118 is formed at another acute angle A1 to the central long axis 108 of the alignment tool 100. The inside face 110 of the tongue 106 is formed at yet another acute angle A3 to the central long axis 108. In one embodiment, angles A1 and A3 are approximately eleven degrees and angle A2 is approximately twenty degrees. Angles A1 and A2 are preferably within a range from ten degrees to twenty degrees. The inside face 110 may optionally extend to the first end of the handle stem 104, or may optionally be interrupted by a change in cross-sectional shape as shown at phantom line C-C in FIG. 4 and in the cross section view C-C of FIG. 6. In the example of FIG. 6, a width dimension D5 and a thickness dimension D4 may optionally be the same as the width dimension D3 of the prying tip 118.

FIG. 4 shows an overall length dimension D2 for the tongue 106, including the distance to the furthest edge on the prying tip 118. In one embodiment of an alignment tool, tongue length dimension D2 is 0.75 inch (0.30 cm). An overall length dimension D2 of the tongue may optionally be selected so that the prying tip 118 on the tongue 106 is unable to press against an alignment seat in a saddle when the tongue of an alignment tool is fully inserted into a string clamping plate slot.

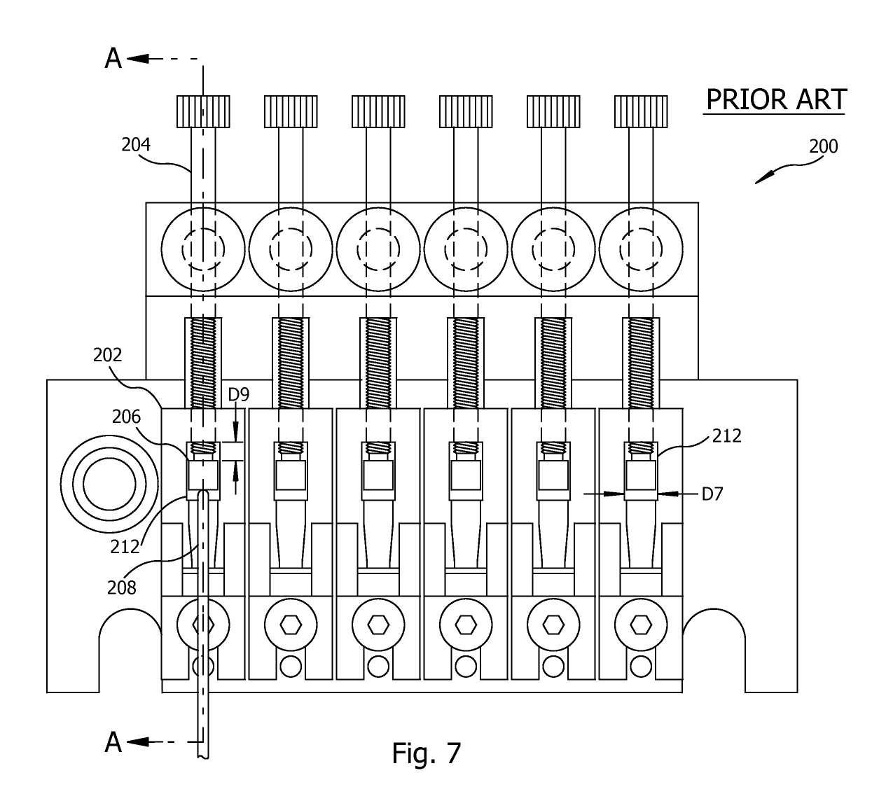

As previously explained, embodiments of the invention are useful for adjustment and repair of double locking tremolos. A view toward the top surface of an example of a double locking tremolo is shown in FIG. 7. Some details are omitted from FIG. 7 since double locking tremolos are well known to one skilled in the arts of guitar construction and repair. The example of a double locking tremolo 200 of FIG. 7 includes a saddle 202 for holding a string 208 between a side of a string clamping plate 206 and a wall of a string clamping plate slot 212. A compression screw 204 presses the string clamping plate 212 against the string 208. The string clamping plate slot 212 has a width dimension D7. A gap between a side of the string clamping plate 206 and an end of the string clamping plate slot 212 has a dimension D9. The dimension D9 is larger for a string 208 having a small diameter than for a string 208 having a large diameter. The diameter of a string 208 may be selected by a guitar player according to a preferred tactile feel for the string, a desire to avoid string breakage, a range of notes to be produced by the string, or other selection criteria.

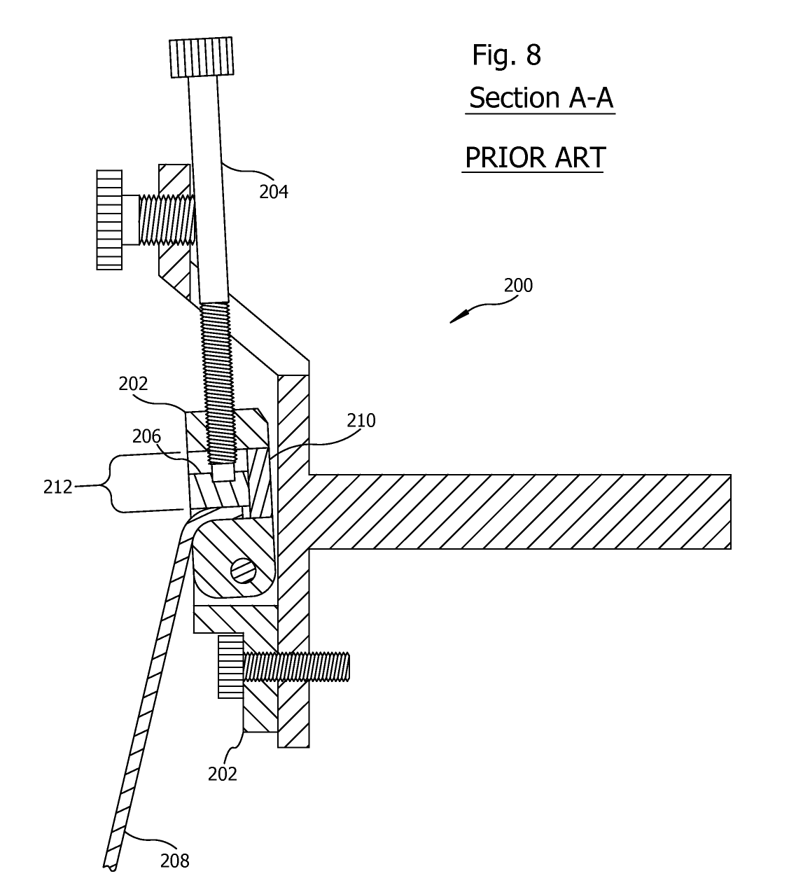

The double locking tremolo of FIG. 7 is shown in a cross section view in FIG. 8. A location and viewing direction for FIG. 8 are indicated by a phantom line labeled A-A in FIG. 7. FIG. 8 shows some parts of a double locking tremolo 200, including the saddle 202, with part of the saddle tipped at an angle, and the string clamping plate slot 202. An alignment seat 210 is pressed into the bottom of the string clamping plate slot 212. A string clamping plate 206 is held in the string clamping plate slot 212 by a compression screw 204. The string clamping plate 206 rests on the upper surface of the alignment seat 210. It is preferable to be able to align a string clamping plate 206 with the compression screw 204, remove a damaged or worn string clamping plate 206, or removed a string 208, without moving the alignment seat 210 from the position it had when the guitar was last adjusted for intonation and tuning.

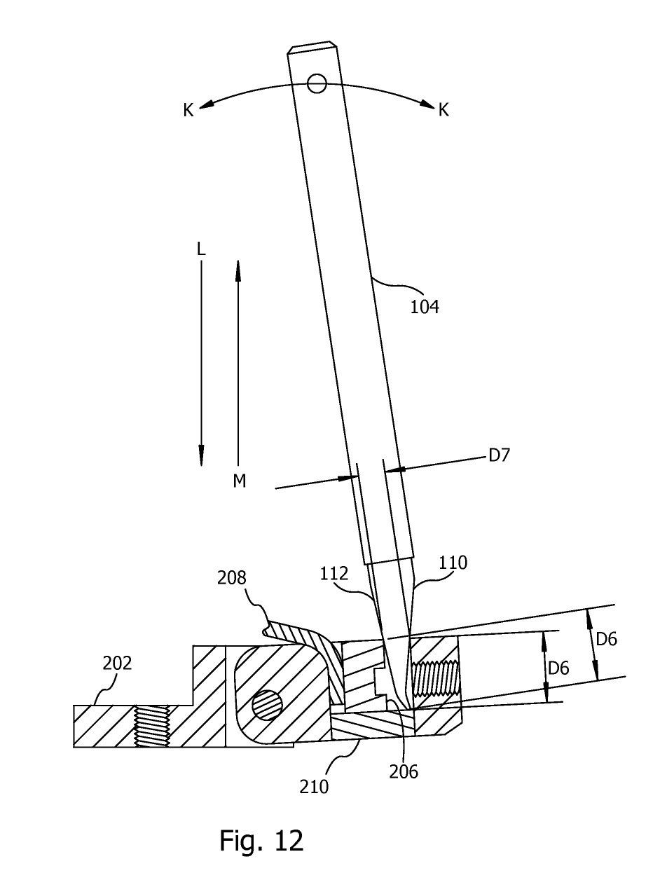

Some embodiments of the invention comprise a combination of a double locking tremolo and an alignment tool. As shown in FIG. 7 and FIG. 8, a double locking tremolo suitable for use with an embodiment of the invention has at least one string clamping plate 206 slidably disposed within a slot 212 in the double locking tremolo 200, an alignment seat 210 held within the slot 212 and upon which the string clamping plate 206 rests, and a vertical separation distance between a top surface of said alignment seat and a top surface of the guitar tremolo, for example the vertical separation distance D6 shown in FIG. 12. An embodiment of the invention comprising a combination may optionally include a string clamping plate extractor as described in U.S. Pat. No. 5,686,681 to Powell.

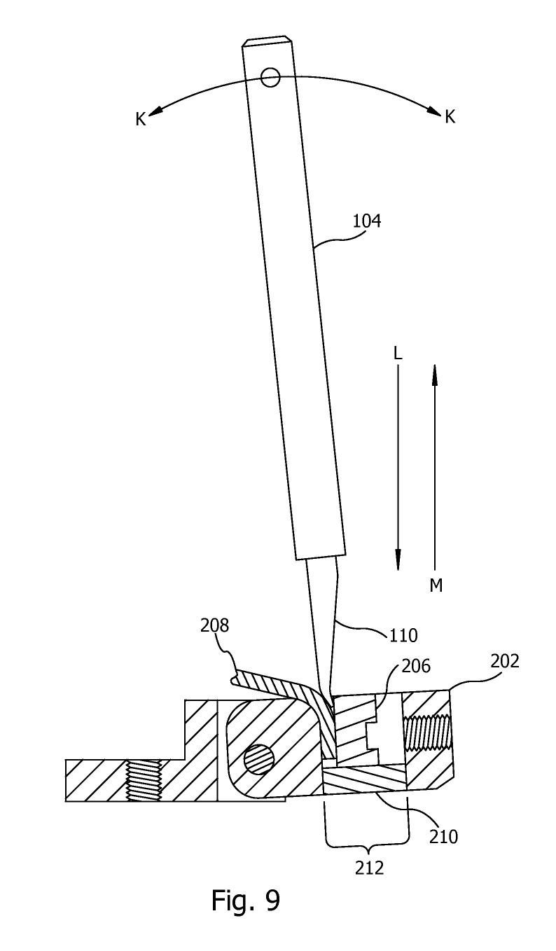

Use of an alignment tool for removing a string, aligning a string clamping plate, or removing a jammed string clamping plate may be explained in relation to FIGS. 9-12. FIGS. 9-12 show various positions of an alignment tool in relation to parts of a saddle 202 from a double locking tremolo. The figures further show a string 208, string clamping plate 206, alignment seat 210, and string clamping plate slot 212. The views of a saddle shown in FIGS. 9-12 correspond to the saddle shown in FIG. 8. FIGS. 9-12 are drawn without threaded fasteners in place, for example the clamping screw 204 shown in FIG. 8. In FIG. 9, the tongue 110 of an alignment tool, and more specifically the prying tip of the tongue, is pressed downward in a direction L into a small gap between a string 208 and a string clamping plate 206. The handle stem 104 is rocked back and forth through an arc in direction K-K while simultaneously inserting the tool in a direction L and withdrawing the tool in a direction M.

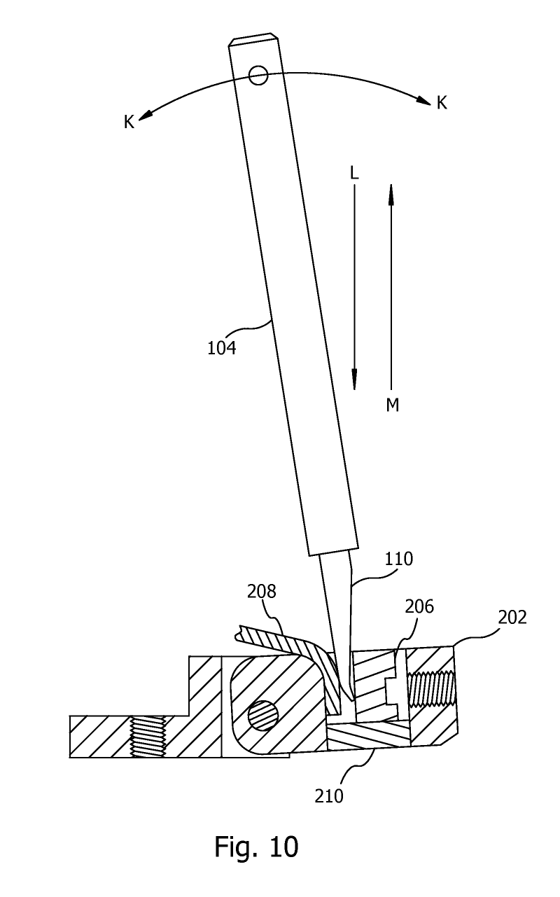

The combined rocking, insertion, and withdrawal motions cause a gap to form between a string to be removed, for example a broken string fragment 208 as shown in FIG. 10, and a side of the string clamping plate 206. The displacement angle of the prying tip relative to the rest of the tongue 110 enables a substantial amount of force to be generated by leverage of the alignment tool against the string alignment plate 206. An alignment tool is capable of generating sufficient force for dislodging a string clamping plate that is firmly jammed into the string clamping plate slot in the saddle 202.

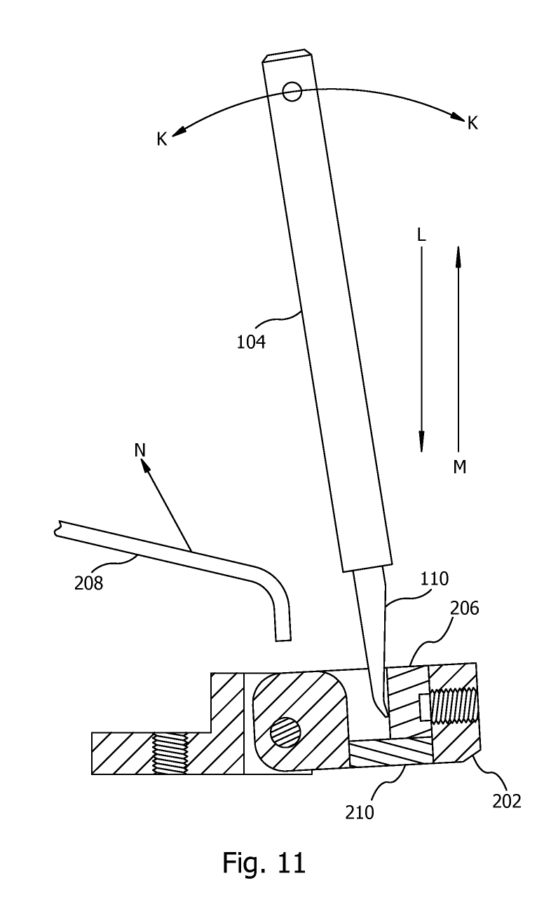

After a jammed string clamping plate has been dislodged and is able to slide within the string clamping plate slot, the alignment tool may optionally be used to align an aperture in the string clamping plate with a threaded hole through which a compression screw passes, as shown in FIG. 11. In some cases it may be necessary to remove foreign matter from the string clamping plate slot with the prying tip of an alignment tool before the string clamping plate can be aligned. A string or string fragment 208 may be removed from the saddle 202 by pulling the string 208 in a direction N away from the saddle 202 with the string clamping plate 206 moved away from contact with the string.

A string clamping plate 206 may optionally be removed from a saddle 202 by placing the string clamping plate in approximately the position shown in FIG. 10, with a gap between a side of the string clamping plate and an end of the string clamping plate slot. Then, an extraction tool, for example the extraction tool described in U.S. Pat. No. 5,686,681, may be inserted into the gap and used to remove the string clamping plate.

Some embodiments of an alignment tool have a thickness dimension selected to prevent the alignment tool from moving an alignment seat when the tool is inserted as far as possible into the string clamping plate slot of a saddle in a double locking tremolo. FIG. 12 illustrates an example of an alignment tool having a thickness dimension D7 at a distance D6 from the end of the alignment tool. Distance D6 corresponds to a dimension from a top surface of an alignment seat to a top surface of a saddle and represents the maximum depth to which an alignment tool may be inserted into a saddle without moving an alignment seat. When the embodiment of an alignment tool shown in FIG. 12 is fully inserted into a saddle 202, the inside face 110 and outside face 112 of the tongue contact an edge of the string compression plate 206 and an edge of the saddle 202, preventing the alignment tool from being inserted into the saddle deeply enough to move the alignment seat 210.

Steps in accord with an embodiment of the invention corresponding to a method represented by FIGS. 9-12 may be summarized as follows:

Loosening a clamping screw pressing a string clamping plate against the string.

Inserting a prying tip of a string clamping plate alignment tool into a gap between the string and the string clamping plate.

Rocking the tool back and forth to expand the gap between the string and the string clamping plate, and removing the string from the double locking tremolo.

The method optionally further comprises the following steps, singly or in combination:

loosening the clamping screw until an end of the clamping screw is flush with an inside edge of a slot in which the string and string clamping plate are held;

resting a back face of the tongue of the string clamping plate alignment tool against the string and applying a force with the prying tip against a side of the string clamping plate by rocking the tongue of the alignment tool back and forth within the slot;

freeing a string clamping plate jammed in the slot by applying a force between the prying tip and a side of the slot;

aligning the string clamping plate for a sliding fit within the slot, after removing the string;

aligning the string clamping plate without moving an alignment seat in the slot;

inserting the tongue of the alignment tool into the slot until the front and back faces of the tongue press against the upper edges of the slot and string clamping plate, thereby preventing the alignment tool from moving the alignment seat in the slot;

removing a string clamping plate from the slot with a string clamping plate extractor;

removing foreign matter from the slot by scraping the prying tip of the alignment tool along the sides of the slot; and

removing a damaged string clamping plate from the slot by pressing against the string clamping plate with the prying tip of the alignment tool.

FIGS. 9-12 illustrate an alignment tool oriented with the inside face 110 of the tongue facing the string clamping plate 206 so that the prying tip on the tongue contacts part of the string clamping plate. The tool may optionally be rotated 180 degrees in FIGS. 9-12 and in any of the examples described herein so that the inside face 110 of the tongue faces away from the string clamping plate 206. Furthermore, during removal of a string, alignment of a string clamping plate, or freeing of a jammed string clamping plate, an alignment tool may optionally be placed between the string and string clamping plate as suggested in FIGS. 9-11, or between the string clamping plate and an end of the string clamping plate slot in the saddle, as suggested in FIG. 12.

Unless expressly stated otherwise herein, ordinary terms have their corresponding ordinary meanings within the respective contexts of their presentations, and ordinary terms of art have their corresponding regular meanings.

What is claimed is:

1. A tool, comprising:
a handle stem having a first end and a central long axis through said first end and said handle stem; and
a tongue attached to said first end,
wherein an end of said tongue has a bend for forming a prying tip and a width of said tongue along said prying tip is selected for a sliding fit in a string clamping plate slot in a double locking tremolo.

2. The tool of claim 1, wherein said prying tip comprises an inner face and an end face sharing an edge in common with said inner face, and said inner face is disposed at an acute angle measured from said inner face through said prying tip to said central long axis.

3. The tool of claim 2, wherein a height dimension of said end face is in a range between 0.01 inch (0.004 cm) and 0.02 inch (0.06 cm).

4. The tool of claim 2, wherein said acute angle is in a range between ten degrees and twenty degrees.

5. The tool of claim 1, further comprising a handle attached perpendicularly to said handle stem.

6. The tool of claim 1, wherein said tongue has a thickness dimension selected to prevent said prying tip from moving an alignment seat in the saddle of a double locking tremolo when said tool is inserted from above into a string clamping plate aperture in the tremolo.

7. The tool of claim 1, wherein said tongue has a width dimension selected for a sliding fit within the width of a string clamping plate aperture in the tremolo.

8. A combination comprising:
a guitar tremolo of the type having at least one string clamping plate slidably disposed within a slot in said guitar tremolo, an alignment seat held within the slot and upon which the string clamping plate rests, and a vertical separation distance between a top surface of said alignment seat and a top surface of said guitar tremolo; and
an alignment tool for aligning said string clamping plate within said slot in said guitar tremolo without moving said alignment seat, comprising:
a handle stem having a first end, a second end, and a central long axis;
a tongue attached to said first end of said handle stem, comprising:
a prying tip comprising:
an inner face;
an end face having an edge in common with said inner face, wherein an angle between said inner face and said central long axis of said handle stem is an acute angle; and
a tip width selected for a sliding fit within the width of a string clamping plate aperture in a saddle in a double locking double locking tremolo; and
a handle suitable for grasping attached to said handle stem near send second end of said handle stem,
wherein said string clamping plate is aligned for sliding adjustment within said slot in said guitar tremolo by a force exerted by said tool against a side of said string clamping plate.

9. The combination of claim 8, further comprising a string clamping plate extractor for removing a string clamping plate aligned by said alignment tool.

10. A method for removing a string from a double locking tremolo, comprising the steps of:
loosening a clamping screw pressing a string clamping plate against the string;
inserting a prying tip of a string clamping plate alignment tool into a gap between the string and the string clamping plate;
rocking the tool back and forth to expand the gap between the string and the string clamping plate; and
removing the string from the double locking tremolo.

11. The method of claim 10, further comprising the step of loosening the clamping screw until an end of the clamping screw is flush with an inside edge of a string clamping plate slot in which the string and string clamping plate are held.

12. The method of claim 10, further comprising the step of resting a back face of the tongue of the string clamping plate alignment tool against the string and applying a force with the prying tip against a side of the string clamping plate by rocking the tongue of the alignment tool back and forth within the spring clamping plate slot.

13. The method of claim 10, further comprising the step of freeing a string clamping plate jammed in the spring clamping plate slot by applying a force between the prying tip and a side of the spring clamping plate slot.

14. The method of claim 10, further comprising the step of aligning the string clamping plate for a sliding fit within the spring clamping plate slot, after removing the string.

15. The method of claim 10, further comprising the step of aligning the string clamping plate without moving an alignment seat in the spring clamping plate slot.

16. The method of claim 14, further comprising the step of inserting the tongue of the alignment tool into the spring clamping plate slot until the front and back faces of the tongue press against the upper edges of the spring clamping plate slot and string clamping plate, thereby preventing the alignment tool from moving the alignment seat in the spring clamping plate slot.

17. The method of claim 10, further comprising the step of removing a string clamping plate from the spring clamping plate slot with a string clamping plate extractor.

18. The method of claim 10, further comprising the step of removing foreign matter from the spring clamping plate slot by scraping the prying tip of the alignment tool along the sides of the spring clamping plate slot.

19. The method of claim 10, further comprising the step of removing a damaged string clamping plate from the spring clamping plate slot by pressing against the string clamping plate with the prying tip of the alignment tool.
